(19) United States
(12) Patent Application Publication
(10) Pub. No.: US 2007/0092592 A1
(43) Pub. Date: Apr. 26, 2007

(54) MOLDING APPARATUS FOR OPTICAL ELEMENTS

(75) Inventor: TSUNG-WEI CHIANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,610

(22) Filed: Aug. 31, 2006

(30) Foreign Application Priority Data
Oct. 21, 2005 (CN) 200510100568.1

(51) Int. Cl. B29C 33/00

(52) U.S. Cl. 425/117; 425/408; 425/112

(57) ABSTRACT

An exemplary molding apparatus (100) includes a first mold core (110), a second mold core (120), a lens holder (130), an elastic member (140) and a mold frame (150). The first mold core is substantially cylindrical and has a first molding surface for press molding a top surface of a lens. The second mold core is substantially cylindrical and has a second molding surface for press molding a bottom surface of the lens. The lens holder has a cavity for fitting the lens. The elastic member is a spring. The elastic member is placed between the lens holder and the second mold core. The first mold core, the second mold core, the lens holder and the elastic member are disposed in the mold frame.

### FIELD OF THE INVENTION

The invention relates generally to molding apparatuses, and more particularly to a molding apparatus for press molding optical elements such as lenses.

### DESCRIPTION OF RELATED ART

In recent times there has been a trend for electrical products, such as digital cameras and mobile phones with digital camera modules, to be compact, lightweight and inexpensive. To meet this demand, a number of simplified lens systems have been developed. However, the manufacturing of lenses using conventional polishing methods is problematic. For this reason, manufacturing lenses by a press molding method has become popular.

A conventional press molding method for making a glass lens involves molding a piece of glass material using a molding apparatus. The molding apparatus generally includes an upper mold core, a lower mold core, and a mold frame for slidably holding the upper and lower mold cores therein. Referring to FIG. 4, a typical molding apparatus 200 includes an upper mold core 210, a lower mold core 220, a lens holder 230, and a mold frame 240. The upper mold core 210 has an upper molding surface 211 in the form of a relief. The lower mold core 220 has a lower molding surface 221 in the form of a relief. When the two mold cores 210, 220 are properly positioned a desired distance apart at a desired rotational orientation relative to each other, their mutually opposite molding surfaces 211, 221 define a relief form corresponding to two opposite recessed surfaces to be formed in a lens preform 400.

The upper mold core 210 and lower mold core 220 are slidably received in a stepped axial through hole of the mold frame 240. Thereby, the mold cores 210, 220 can be accurately guided so that the molding surfaces 211, 221 slide toward and respectively press the lens preform 400 precisely.

In use of the molding apparatus 200, the lens preform 400 is placed on the lower molding surface 221 of the lower mold core 220. Because the lower molding surface 221 is generally convex relative to the lens preform 400, the positioning of the lens preform 400 is unstable. That is, the lens preform 400 is liable to shift from the center of the lower molding surface 221 during the press molding process. In addition, because the molding process is typically performed at high pressure, the lens preform 400 often adheres to the lower molding surface 221. Then it is difficult to separate the duly formed lens from the lower molding surface 221.

What is needed, therefore, is a molding apparatus which provides highly accurate fitting of a lens preform between mold cores, and which provides easy separation of a formed lens from either or both of the mold cores.

### SUMMARY OF INVENTION

A molding apparatus for press molding optical elements is provided. In one embodiment, the molding apparatus includes a first mold core, a second mold core, a lens holder, an elastic member, and a mold frame. The first mold core is substantially cylindrical, and defines a convex first molding surface for press molding a top surface of a lens preform. The second mold core is substantially cylindrical, and defines a convex second molding surface for press molding a bottom surface of the lens preform. The lens holder defines a cavity in a center of a top portion thereof, for fitting the lens preform therein during molding. The lens holder further defines a central through hole, for allowing the second molding surface to pass up therethrough and press the bottom surface of the lens preform.

The elastic member can be a spring or a hollow rubber cylinder. The elastic member is positioned between the lens holder and the second mold core. The first mold core, the second mold core, the lens holder and the elastic member are disposed in the mold frame. The first mold core and the second mold core are matched with each other to define a shape of the lens.

Advantages and novel features of the present molding apparatus will become more apparent from the following detailed description of preferred embodiments when taken in conjunction with the accompanying drawings.

### BRIEF DESCRIPTION OF DRAWINGS

The components in the drawings are not necessarily drawn to scale, the emphasis instead being placed upon clearly illustrating the principles of the present invention.

FIG. 1 is an exploded, isometric view of a molding apparatus in accordance with a preferred embodiment of the present invention, together with a lens preform.

FIG. 2 is a side cross-sectional view of the molding apparatus of FIG. 1 assembled and ready to mold the lens preform.

FIG. 3 is similar to FIG. 2, but showing the lens being press molded by a first mold core and a second mold core of the molding apparatus.

FIG. 4 is a side cross-sectional view of a conventional molding apparatus ready to mold a lens preform positioned therein.

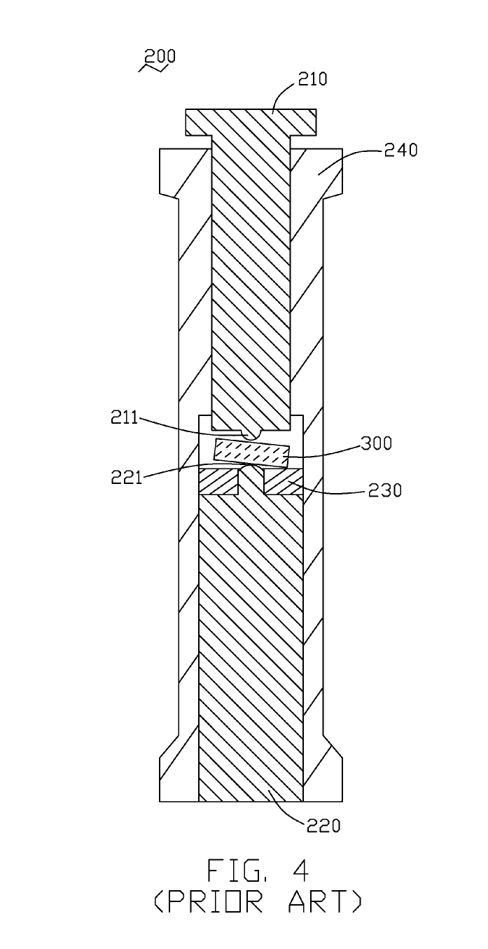

Corresponding reference characters indicate corresponding parts throughout the several views. The exemplifications set out herein illustrate at least one preferred embodiment of the present molding apparatus, in one form, and such exemplifications are not to be construed as limiting the scope of the invention in any manner.

### DETAILED DESCRIPTION

Reference will now be made to the drawings to describe embodiments of the present molding apparatus in detail.

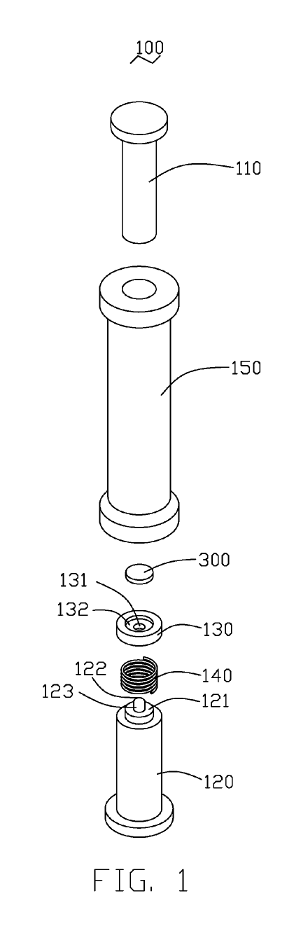

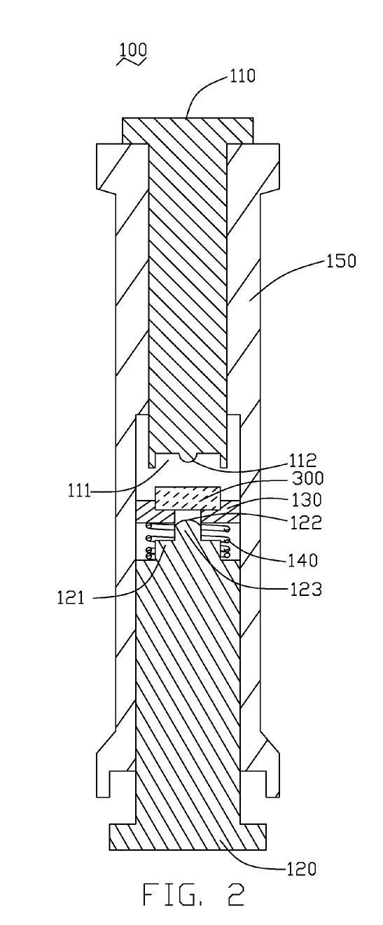

Referring to FIG. 1, a molding apparatus 100 for press molding optical elements according to a preferred embodiment of the present invention is shown. The molding apparatus 100 includes a first mold core 110, a second mold core 120, a lens holder 130, an elastic member 140, and a mold frame 150. Also referring to FIG. 2, the first mold core 110 is substantially cylindrical. The first mold core 110 defines a concavity 111 at a bottom end thereof, for receiving a lens preform 300 therein. The first mold core 110 has a convex first molding surface 112 in the concavity 111, for press molding a top surface of the lens preform 300. The first mold core 110 is movably positioned in the mold frame 150.

The second mold core 120 is substantially cylindrical. The second mold core 120 includes a stamp 121 at a top end thereof. A protrusion portion 123 protrudes up from the stamp 121. A convex second molding surface 122 is defined on the protrusion portion 123, for press molding a bottom surface of the lens preform 300. Thus when the two mold cores 110, 120 are properly positioned a desired distance apart at a desired rotational orientation relative to each other, their mutually opposite molding surfaces 112, 122 define a relief form corresponding to opposite recessed top and bottom surfaces to be formed in the lens preform 300.

The lens holder 130 defines a cavity 132 in a center of a top portion thereof. The lens preform 300 can be positioned and held in the cavity 132 of the lens holder 130. The cavity 132 of the lens holder 130 is vertically opposite to the concavity 111 of the first mold core 110. A combined size of the cavity 132 of the lens holder 130 and the concavity 111 of the first mold core 110 substantially corresponds to a size of the lens preform 300. The lens holder 130 also defines a central through hole 131, for allowing the second molding surface 122 to pass up therethrough and press the bottom surface of the lens preform 300.

The lens preform 300 can be a piece of glass material. For example, heavy crown glass (refractive index=1.58 and glass transition temperature=506° C.) and lanthanum crown glass (refractive index=1.67 and glass transition temperature=530° C.) are typically used as glass materials to mold an aspherical concave lens. The various components of the molding apparatus 100 should be made from proper materials, because this can be crucial for optimization of optical molding. A high quality mold steel that has a high compression strength, excellent wear resistance, toughness, corrosion resistance, and high hardness at elevated temperatures is typically chosen as a material of the first mold core 110, the second mold core 120, the lens holder 130, and the mold frame 150.

The elastic member 140 can be a helical spring or a hollow rubber cylinder. The elastic member 140 is placed around the stamp 121 of the second mold core 120, and is positioned between the lens holder 130 and the second mold core 120. The lens holder 130 is supported by the elastic member 140. The elastic member 140 can be compressed when the second mold core 120 is moved close to the first mold core 110. The elastic member 140 can also release the second mold core 120 from the lens preform 300 when the press molding process is completed.

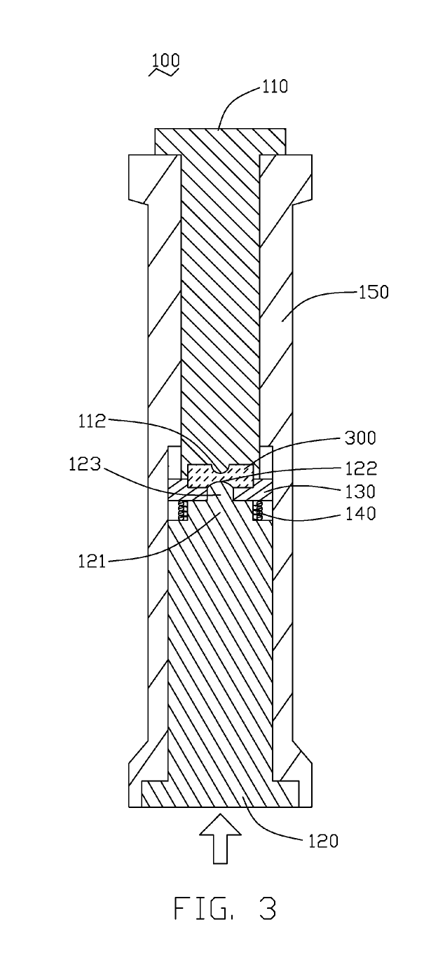

The process of press molding the lens preform 300 is as follows. The first mold core 110, the second mold core 120, the lens holder 130, the elastic member 140, and the lens preform 300 are positioned in the mold frame 150. Also referring to FIG. 3, during the pressing stage, the first mold core 110 is fixed and the second mold core 120 is pushed up in the mold frame 150. The second molding surface 122 of the second mold core 120 passes up through the through hole 131 of the lens holder 130 gradually until the second molding surface 122 contacts the bottom surface of the lens preform 300. The second molding surface 122 and the first molding surface 112 apply pressure to the bottom and top surfaces of the lens preform 300 respectively at a high temperature at which press deformation is possible. Typically, a mold heater (not shown) is arranged around the mold apparatus 100 to heat the lens preform 300 to the required temperature. Finally, the lens preform 300 attains a shape having opposite recessed top and bottom surfaces that correspond to the first molding surface 112 and the second molding surface 122 respectively.

During the pressing stage, the elastic member 140 is substantially compressed. After the pressing force applied to the lens preform 300 by the first molding surface 112 and the second molding surface 122 is released (i.e. substantially zero), the elastic member 140 rebounds and pushes the second mold core 120 away from the lens holder 130. Thereby, the second molding surface 122 is released from the bottom surface of the formed lens. The formed lens can subsequently be taken out from the lens holder 130 easily.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A molding apparatus for optical elements, comprising:
a first mold core;
a second mold core;
a lens holder positioned between the first mold core and the second mold core and configured for holding a lens preform;
an elastic member positioned between the lens holder and the second mold core; and a mold frame;
wherein the first mold core is positioned in the mold frame, and the second mold core, the lens holder and the elastic member are movably positioned in the mold frame.

2. The molding apparatus as claimed in claim 1, wherein the first mold core is movably positioned in the mold frame.

3. The molding apparatus as claimed in claim 1, wherein the first mold core is substantially cylindrical.

4. The molding apparatus as claimed in claim 1, wherein the first mold core defines a concavity at a bottom end thereof, and the concavity is configured for receiving at least a part of the lens preform therein.

5. The molding apparatus as claimed in claim 4, wherein the first mold core further comprises a first molding surface in the concavity thereof, and the first molding surface is configured for press molding one surface of the lens preform.

6. The molding apparatus as claimed in claim 5, wherein the first molding surface is convex.

7. The molding apparatus as claimed in claim 1, wherein the second mold core is substantially cylindrical.

8. The molding apparatus as claimed in claim 1, wherein the second mold core comprises a stamp at a top end thereof.

9. The molding apparatus as claimed in claim 8, wherein the second mold core further comprises a protrusion portion protruding up from the stamp thereof.

10. The molding apparatus as claimed in claim 9, wherein the second mold core defines a second molding surface on the protrusion portion thereof, and the second molding surface is configured for press molding one surface of the lens preform.

11. The molding apparatus as claimed in claim 10, wherein the second molding surface is convex.

12. The molding apparatus as claimed in claim 1, wherein the lens holder defines a cavity in a top portion thereof, and the cavity is configured for holding the lens preform.

13. The molding apparatus as claimed in claim 12, wherein the lens holder further defines a through hole, and the through hole is configured for allowing the second molding surface to pass up therethrough.

14. The molding apparatus as claimed in claim 1, wherein the elastic member is a spring.

15. The molding apparatus as claimed in claim 1, wherein the elastic member is a hollow rubber cylinder.
